(19) United States
(12) Patent Application Publication
(10) Pub. No.: US 2009/0158157 A1
(43) Pub. Date: Jun. 18, 2009

(54) PREVIEWING RECORDED PROGRAMS USING THUMBNAILS

(75) Inventors: Kevin Shields, Bellevue, WA (US); Li-Juan Qin, Beijing (CN); Charles Wu, Bellevue, WA (US); Mark Schwesinger, Bellevue, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/956,702

(22) Filed: Dec. 14, 2007

(51) Int. Cl. G06F 3/048

(52) U.S. Cl. 715/723

(57) ABSTRACT

A method and system are disclosed for selecting representative information from a video clip to aid in identifying the video clip. The video clip may be a recorded television program and the representative information may be thumbnails determined to a high degree of certainty to include identifying content from the television program. When a user accesses a list of recorded video clips, the identifying information for each clip may be presented to the user to further assist the user in identifying the recorded video clip.

### BACKGROUND

In recent years, the number of personal video recorders (PVRs), such as set-top digital video recorders (DVRs) and media center PCs, in homes has increased considerably. Generally speaking, a conventional PVR is a device that records video to a hard drive-based digital storage media. This makes the “timeshifting” feature (more traditionally done by a VCR) much more convenient, and also allows for other features such as pausing live TV, instant replay of interesting scenes, chasing playback where a recording can be viewed before it has been completed, skipping advertising, and the like.

In conventional DVRs, recorded programs are typically accessed through a textual list including metadata regarding recorded programs. The metadata typically includes the names and descriptions of the recorded programs, as well as the title of a specific program and the time and date of the airing. When the DVR mode is used to record a series of regular weekly programming it can be difficult to pick a single episode out of a lineup of prerecorded shows because the metadata for the series does not always contain episode specific information. Sometimes the only mechanism available is to simply choose one episode in a series and watch part of it to see if this is the one you are looking for but that method is clumsy and time consuming.

### SUMMARY

Embodiments of the present system relate to a method for selecting a representative thumbnail from a video clip, which may for example be a recorded television program. The technology involves analyzing frames of the video clip to determine which frames are stable, the end result of the analysis being a number of segments of stable frames. From the stable segments, a number of candidate segments are selected, where candidate segments are those segments determined to a degree of certainty to be program content, as opposed to other content like advertising. The representative thumbnail is then selected from among the frames of the candidate segments.

The representative thumbnails are stored in association with other metadata identifying the video clip. When a user accesses a user interface for displaying a list of recorded video clips, one or more of the representative thumbnails may also be displayed to further assist in the identification of the video clip from the metadata.

In alternative embodiments, instead of using thumbnails as the representative information, segments from the audio soundtrack of the recording may be used. In such embodiments, representative audio segments may be selected which include program content to a high degree of certainty. In further embodiments, the closed captioning text of a television recording may be collected and analyzed to produce a summary or description of the program which gets stored with the metadata of the recorded program and further assists with the identification of the recorded program.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an exemplary computing system environment for implementing embodiments.

FIG. 2 illustrates a block diagram of a system for selecting a smart thumbnail from a video clip, in accordance with various embodiments.

FIG. 3 illustrates a flowchart for a process for selecting a representative thumbnail from a video clip, in accordance with various embodiments.

FIG. 4 illustrates a flowchart for selecting a preliminary thumbnail, in accordance with an embodiment.

FIG. 5 illustrates a flowchart for a process for analyzing frames of a video clip to determine which frames are stable, in accordance with an embodiment.

FIG. 6 illustrates a flowchart for determining stable segments based on a threshold value.

FIG. 7 illustrates a flowchart for determining which of the stable segments are to be candidate segments, in accordance with various embodiments.

FIG. 8 illustrates a flowchart for selecting a representative thumbnail from the candidate segments, in accordance with an embodiment.

FIG. 9 illustrates a flowchart for selecting a recorded program using a representative thumbnail image stored in association with recorded programs.

FIG. 10 illustrates a flowchart for selecting a recorded program using a plurality of representative thumbnail images stored in association with recorded programs.

### DETAILED DESCRIPTION

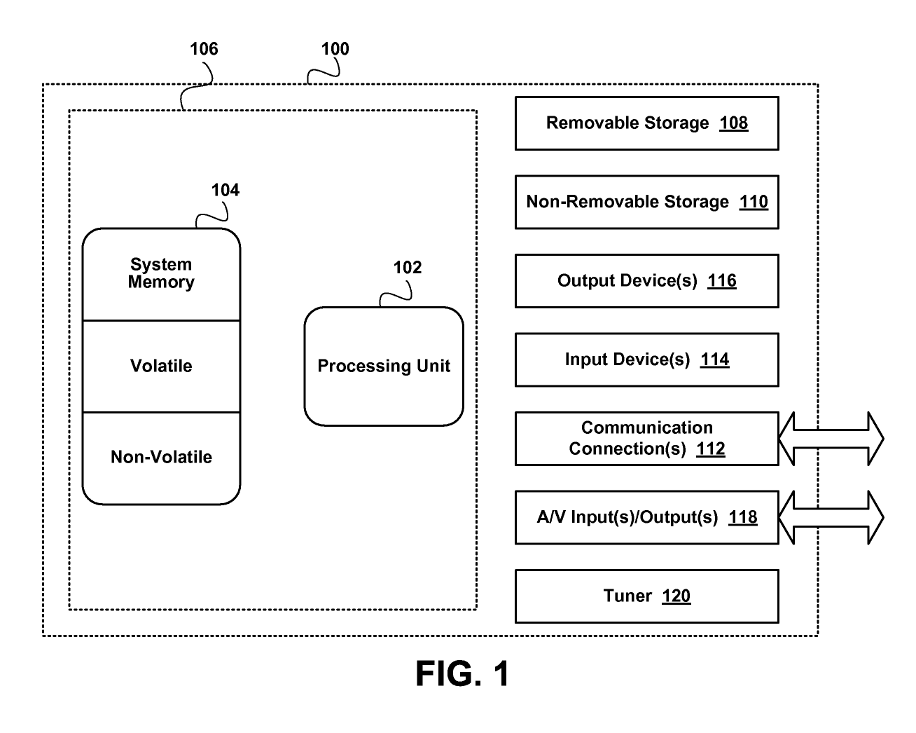

Embodiments of the invention will now be described with reference to FIGS. 1-10, which in general relate to methods of selecting representative video frames from recorded programs. The representative video frames are included as thumbnails in the metadata to allow easy identification of recorded programs. The methods described herein can be performed on a variety of processing systems to display images on a monitor. The display monitor may be a television set, but may also be a computer monitor.

As outlined above, conventional PVRs do not provide a graphical indicator, such as a thumbnail, to aid a user in identifying a recorded program. Described herein is technology for, among other things, selecting a representative thumbnail from a video clip. The thumbnail cannot simply be selected at random, because program content versus non-program content needs to be distinguished. Non-program content includes, for instance, commercials, credit sequences, blurry frames, black frames, etc. Other factors such as padding time at the beginning and/or end of a recording also need to be considered. Consequently, the technology involves analyzing frames of the video clip to determine which frames are stable, the end result of the analysis being a number of segments of stable frames. From the stable segments, a number of candidate segments are selected, where candidate segments are those segments determined to a degree of certainty to be program content. The representative thumbnail is then selected from among the frames of the candidate segments. Although a single representative thumbnail will be selected in some situations multiple thumbnails could be used to provide additional information about the program for the user.

The following discussion will begin with a description of an example operating environment for various embodiments. Discussion will proceed to a description of the structure of a smart thumbnail selection system 200. Discussion will then proceed to descriptions of implementation of example methods for selecting smart thumbnails.

With reference to FIG. 1, an exemplary system for implementing embodiments includes a general purpose computing system environment, such as computing system environment 100. In various embodiments, the computing system environment 100 may be a personal video recorder (PVR) such as a standalone PVR, a PVR integrated into a set-top box, a media center PC, and the like. In its most basic configuration, computing system environment 100 typically includes at least one processing unit 102 and memory 104. Depending on the exact configuration and type of computing system environment, memory 104 may be volatile (such as RAM), non-volatile (such as ROM, flash memory, etc.) or some combination of the two. This basic configuration is illustrated in FIG. 1 by dashed line 106.

Additionally, computing system environment 100 may also have additional features/functionality. For example, computing system environment 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and nonremovable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 100. Any such computer storage media may be part of computing system environment 100.

Computing system environment 100 may also contain communication connection(s) 112 that allow it to communicate with other devices. Communication connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. Computing system environment 100 may also have input device(s) 114 such as a keyboard, mouse, pen, voice input device, touch input device, remote control input device, etc. Output device(s) 116 such as a display, speakers, printer, etc. may also be included. All these devices are well known in the art and need not be discussed at length here.

The computing system environment 100 may also include a number of audio/video inputs and outputs 118 for receiving and transmitting video content. These inputs and outputs 118 may include, but are not limited to, coaxial, composite video, S-video, HDMI, DVI, VGA, component video, optical, and the like. It should be appreciated that since video content may be delivered over an Internet connection, a network interface may therefore also be considered an A/V input on which video content is received. In addition, the computing system environment 100 may also include a tuner 120 for selecting specific channels for receiving video content. The tuner 120 may be coupled with a cable card (not shown) in order to enable the tuning of certain digital channels.

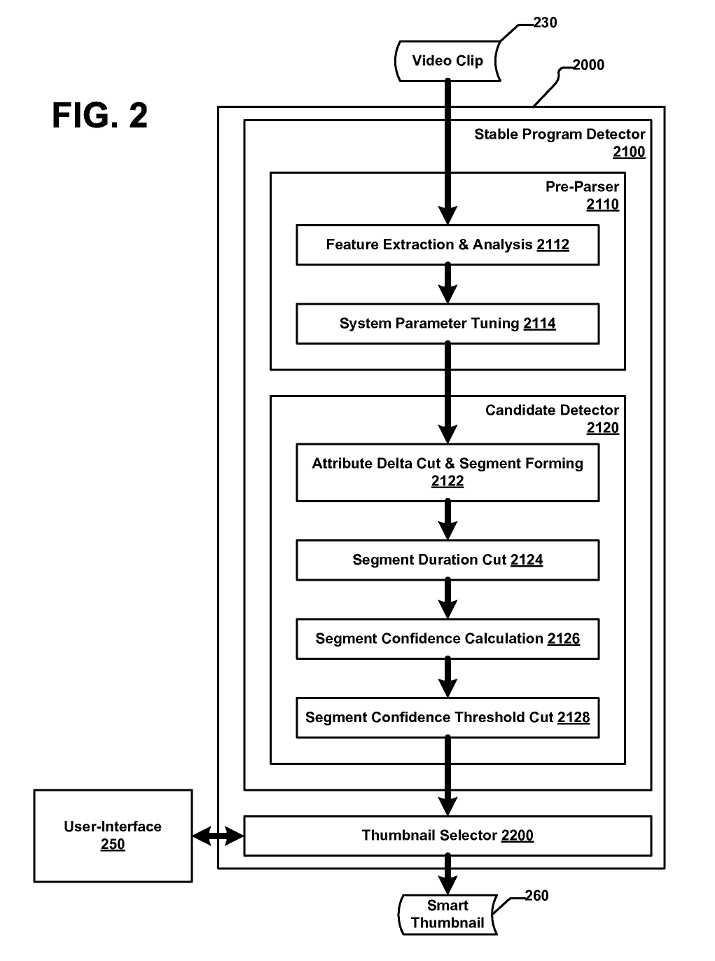

Referring now to the block diagram of FIG. 2, a system will now be explained for selecting a representative image, also referred to as a smart thumbnail. FIG. 2 illustrates a system 2000 for selecting a smart thumbnail 260 from a video clip 230, in accordance with various embodiments. In one embodiment, the video clip 230 is a recording of a television program on a PVR.

The present system for selecting a smart thumbnail is format agnostic, and video clip 230 may be a number of different formats including, but not limited to, MPEG, AVI, DVR-MS, WTV (the Media Center formats) and WMV.

System 2000 includes a stable program detector 2100 that is operable to determine one or more candidate segments from the video clip 230. As used herein, candidate segments refer to segments of the video clip 230 that are determined to a degree of certainty to be program segments. In addition, the candidate segments are also relatively more “stable” than other segments. This special property guarantees that a thumbnail selected from these candidate segments has good visual quality and also has a high probability to be program content, the reason being that the more stable a frame is, the better the quality will be. Moreover, program parts of a video clip 230 tend to be more stable than non-program parts as well. A smart thumbnail 260 is then selected from these candidate segments by a thumbnail selector 2200 (discussed in greater detail below).

The stable program detector 2100 includes a pre-parser 2110, which is operable to analyze frames of the video clip 230 to determine which frames are stable. In other words, the frames of the video clip 230 are determined to be either stable or non-stable. A stable frame is a frame that exhibits a low degree of movement and/or change with respect to the preceding and following frames. The resulting stable frames make up a plurality of stable segments (i.e., one or more stable frames in sequence). In one embodiment, the pre-parser 2110 includes a feature extraction and analysis portion 2112, which is operable to determine attributes of frames of the video clip 230. Such attributes may include, but are not limited to, color histograms, gray histograms, brightness, contrast, and the number of motion vectors in a given frame.

In one embodiment, only i-frames (e.g., in the case of MPEG videos) of video clip 230 are used. By extracting the attributes of the frames of the video clip 230, a series of attributes are therefore obtained, together with their timestamps. In one embodiment, the pre-parser 2110 also includes a system parameter tuning portion 2114, into which the attributes are input. The system parameters tuning portion 2114 calculates, with respect to a particular frame, an attribute delta between that frame and the frame prior to and after it.

The stable program detector 2100 also includes a candidate detector 2120, which is operable to determine the candidate segments from among the stable segments. In one embodiment, the candidate detector 2120 includes an attribute delta cut and segment forming portion 2122. The attribute delta cut and segment forming portion 2122 is operable to classify the frames of the video clip 230 into two classes (e.g., stable and non-stable) based on their respective attribute deltas. In one embodiment, this is accomplished by comparing the attribute deltas to a threshold value. Moreover, the threshold value may be geography-sensitive. For example, picture quality in one location may generally be poorer than another. Thus, embodiments may be operable to detect and obtain (e.g., via a communication interface such as communication connections 112) geography-based information to be used in determining a threshold value. Once the stable frames have been determined, connecting the stable frames results in a set of stable video segments.

It should be appreciated that some of the stable segments generated by the attribute delta cut and segment forming portion 2122 may be very short. To suppress the effect of these noises, the candidate detector 2120 in one embodiment may include a segment duration cut portion 2124, which is operable to smooth the segment series by removing some segments based on their lengths. In one embodiment, this is achieved by removing segments shorter than a durational threshold (Lₜ).

In one embodiment, the stable segments are then fed into a segment confidence calculation portion 2126. As the name suggests, the segment confidence calculation portion 2126 is operable to calculate confidence measures for the stable segments. This measure indicates the possibility that the corresponding segment is program as opposed to non-program content. The higher the measure is, the greater the possibility that the corresponding segment is a real program segment. It should be appreciated that the confidence measure may be calculated in a number of ways. For example, and not by way of limitation, the segment may be composed of two parts, including an intra confidence portion and an inter confidence portion. An intra confidence portion may be calculated using the features within the segment, while an inter confidence portion may be calculated using the features of the neighbor's segments. The following equations illustrate in greater detail such calculations, using color histogram as an example attribute. It should be appreciated that other manners of calculating confidence measures are possible.

$$\begin{matrix}{C}_{intra}^{i} = {con}_{1} \cdot \frac{{L}_{i} - {L}_{t}}{{L}_{Max}} + {con}_{2} \cdot \frac{\overline{{HDif}_{i}}}{{HDif}_{t}} & ( 1 ) \\ \overline{{HDif}_{i}} = \frac{{\sum }_{j = 1}^{{L}_{i}} {HDif}_{ij}}{{L}_{i}} & ( 2 ) \\ {C}_{inter}^{i} = {con}_{3} \cdot ( ( 1 - \frac{{Lpre\_c}_{i} + {Lpost\_c}_{t}}{2 \cdot {Lc}_{Max}} ) + ( \frac{{Lpre\_p}_{i} + {Lpost\_p}_{i}}{2 \cdot {Lneighbor}_{1}} ) ) + {con}_{4} \cdot \frac{\overline{{HDifpre}_{i}} + \overline{{HDifpost}_{i}}}{2 \cdot {HDif}_{t}} & ( 3 ) \\ \overline{{HDifpre}_{i}} = \frac{{\sum }_{j = Si - {Lneighbor}_{2}}^{Si - 1} {HDif}_{ij}}{{Lneighbor}_{2}} & ( 4 ) \\ \overline{{HDifpost}_{i}} = \frac{{\sum }_{j = Ei - 1}^{Ei + {Lneighbor}_{2}} {HDif}_{ij}}{{Lneighbor}_{2}} & ( 5 )\end{matrix}$$

In Equations 1 and 3, con₁, con₂, con₃, and con₄ represent four weight parameters, which can be optimized by searching the parameter space. In Equation 1, Lᵢ represents the length of the i^{th} stable segment. Lₜ represents the durational threshold used by the segment duration threshold cut portion 2124 above. Lₘₐₓ is the maximum length of all stable segments. H̅D̅i̅f̅ᵢ̅ indicates the average histogram difference in Lᵢ. HDifₜ is the histo-difference threshold used by the attribute delta cut and segment forming portion 2122.

In Equation 3, Lpre_cᵢ stands for the length of the non-stable segments prior to the i^{th} stable segment, while Lpost_cᵢ stands for the length of the non-stable segments after it. Lcₘₐₓ is the maximum length of all non-stable segments. Accordingly, Lpre_μl is the length of the stable segments prior to the i^{th} stable segment in a region where a length of Lneighbor₁, and Lpost_pᵢ is the length of stable segments after it within a region with the same length, Lneighbor₁.

Equations 4 and 5 illustrate one manner of calculating the average histogram difference in a region with length of Lneighbor₂ prior to and following the i^{th} stable segment. In Equation 4, Sᵢ is the start point of the segment, and in Equation 5, Eᵢ is the endpoint.

After the calculation of confidence measures, the program candidates are assigned confidence factors. In one embodiment, the candidate detector 2120 includes a segment confidence threshold cutting portion 2128, which is operable to determine one or more candidate segments from the stable segments based on the confidence factors determined above a confidence threshold. In other words, only stable segments with a confidence factor higher than the confidence threshold are selected as the candidate (i.e., program) segments. Stable segments with confidence factors lower than this threshold are taken as non-program segments. In one embodiment, the confidence threshold is determined by a known K-Mean method. The resulting output of the segment confidence threshold cutting portion 2128, and thus the candidate detector 2120, is one or more candidate segments that are determined to be program content to a degree of certainty.

These candidate segments are then passed to the thumbnail selector 2200, which selects the smart thumbnail 260 from the frames of the candidate segments. The selected smart thumbnail 260 may be composed of the most prominent images seen during the recorded program. It should be appreciated that several different strategies of thumbnail selection may be used by the thumbnail selector 2200 in order to select the most prominent images. Moreover, in one embodiment, the strategy employed may be selected manually via a user interface 250. Example strategies for thumbnail selection will now be described. Such examples are for purposes of illustration and not for limitation.

In one embodiment, the thumbnail selector 2200 selects the most stable frame in the highest confidence candidate segment. The stableness of a frame may be represented by its histogram delta. The smaller the histogram delta the more stable the frame is. It follows that the highest confidence candidate segment is the candidate segment that has the highest confidence factor. Thus, the smart thumbnail 260 would comprise the frame with the smallest histogram delta from the candidate segment with the highest confidence factor.

In another embodiment, the thumbnail selector 2200 selects the highest contrast frame in the highest confidence segment. The contrast of frame may be measured by its color entropy (where the distribution is the normalized color histogram). The higher the entropy of a frame, the larger the contrast. Thus, the smart thumbnail 260 would comprise the frame with the highest entropy from the candidate segment with the highest confidence factor.

In another embodiment, the thumbnail selector 2200 selects a frame with a character face in the highest confidence segment. Frames with character faces are more likely to be manually selected to be a representative thumbnail of a video by users, since frames with character faces have more information than other frames. Therefore, these frames are thought to be more representative. In this strategy, the frame with the highest face measure, which is the ratio between the area of detected face and the frame size, in the candidate segment having the highest confidence factor, is selected as the smart thumbnail 260.

In one embodiment, the pictures selected for display may be selected for their differentiating characteristics, to enable the displayed smart thumbnails to present a diverse collection of images that increases the likelihood that the set of pictures chosen will inform the user as to the content of the particular episode. For example, it may happen that a recorded show is a daily or weekly show with a host or hostess. In these recorded shows, the frame with the character face in the highest confidence segment is likely going to be the host or hostess. While a viewer may be able to identify a show from this frame, it may alternatively be more advantageous to choose the next highest occurrence of a character face. In particular, as subsequent candidate pictures are created from the show, the ones to be displayed in this embodiment may be chosen for their differentiation against the first picture created (that of the host/hostess) yet are still prominent within the program. This increases the likelihood that the subsequent pictures will be of the guests, which enables the user to differentiate the given episode from others in the series.

In this embodiment, the differentiated smart thumbnail may for example be a stable segment with a confidence factor slightly lower than the stable segment with the highest confidence factor. As explained hereinafter, several smart thumbnails may be stored in association with a recorded program. In such embodiments, the plurality of stored thumbnails may be that of the host/hostess (highest occurrence) as well as one or more guests (the one or more next highest occurrences).

In another embodiment, the thumbnail selector 2200 selects the highest-quality frame in the highest confidence segment. The compound quality of a frame may be measured by its brightness, entropy (contrast), histogram delta (stableness), and face measure, for example. The brightness of a frame is the average intensity over all pixels in the frame. Accordingly, all frames in the highest-confidence candidate segment are filtered by a brightness threshold, thus ruling out the relatively darker frames. The remaining frames may then be measured by a quality equation, such as:

$${Q}_{i} = \frac{{EDR}_{i} + {MFace}_{i}}{2} \\ {EDR}_{i} = \frac{( {Entropy}_{i} / {HDif}_{i} )}{MAX \{ {Entropy}_{j} / {HDif}_{j} \vert j ∈ {Seg}_{max conf} \}} . \qquad ( 6 )$$

In Equation 6, Seg_{maxconf} represents the frame set in the highest-confidence candidate segment, EDRᵢ denotes the entropy histogram difference ratio of the i^{th} frame in Seg_{maxconf}, and MFaceᵢ is its face measure. Thus, the frame with the highest-quality measure (Qᵢ) is selected as the smart thumbnail 260.

In another embodiment, the thumbnail selector 2200 selects the highest quality frame in the largest candidate segment cluster. In this strategy, the candidate segments may be clustered first by their color histogram difference. The thumbnail selector 2200 may then select the frame with the highest-quality (Equation 6) from the largest segment cluster as the smart thumbnail 260. Any clustering algorithms, such as K-Mean, can be adopted here.

In one embodiment, the smart thumbnail 260 is user-selected from the candidate segments. For example, the candidate segments may be provided on a display. The display may be a television, a computer monitor, or the like. Next, an indication of a selected frame may be received, for example, via user interface 250. Due to higher frame rates, the frame selected by a user may not be the best quality frame as compared to neighboring frames. For example, a particular item in the picture may be blurred. Thus, the qualities of the selected frame and a number of neighboring frames may be analyzed. Then, the highest quality of the analyzed frames may be selected as the representative thumbnail.

In one embodiment, once the smart thumbnail 260 has been determined, system 2000 is operable to store the smart thumbnail 260, along with any relevant metadata, back into the video clip 230. This allows the smart thumbnail 260 to be portable. For example, the video clip 230 could thereafter be transferred to a second device. The second device may then reuse the smart thumbnail 260 as determined by system 2000 without doing any analysis of its own.

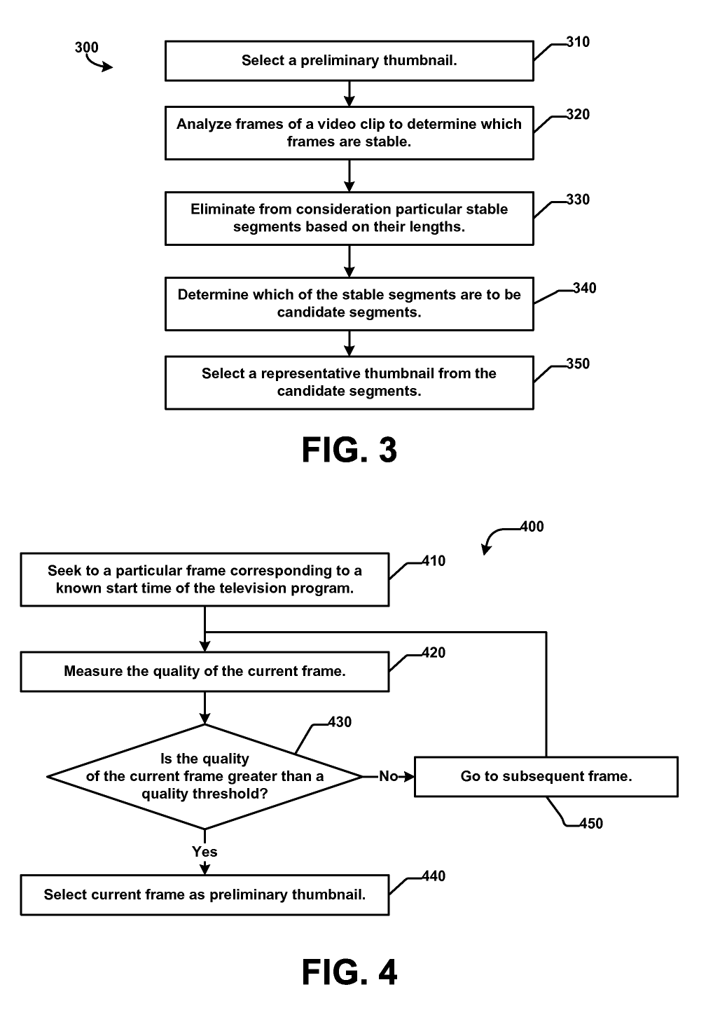

The following discussion sets forth in detail the operation of present technology for selection of a thumbnail from a video clip. With reference to FIGS. 3-8, flowcharts 300, 400 500, 600, 700 and 800 each illustrate example steps used by various embodiments of the present technology selection of a thumbnail from a video clip. Flowcharts 300, 400, 500, 600, 700 and 800 include processes that, in various embodiments, are carried out by a processor under the control of computer-readable and computer-executable instructions. The computer-readable and computer-executable instructions reside, for example, in data storage features such as computer usable memory 104, removable storage 108, and/or non-removable storage 110 of FIG. 1. The computer-readable and computer-executable instructions are used to control or operate in conjunction with, for example, processing unit 102 of FIG. 1. Although specific steps are disclosed in flowcharts 300, 400, 500, 600, 700 and 800, such steps are examples. That is, embodiments are well suited to performing various other steps or variations of the steps recited in flowcharts 300, 400, 500, 600, 700 and 800. It is appreciated that the steps in flowcharts 300, 400, 500, 600, 700 and 800 may be performed in an order different than presented, and that not all of the steps in flowcharts 300, 400, 500, 600, 700 and 800 may be performed.

FIG. 3 illustrates a flowchart 300 for a process for selecting a representative thumbnail from a video clip, in accordance with various embodiments. At block 310, a preliminary thumbnail is optionally selected. It should be appreciated that the selection may be achieved in a number of ways. FIG. 4 illustrates a flowchart 400 of an example method of step 310 for selecting a preliminary thumbnail, in accordance with an embodiment. Block 410 of flowchart 400 involves seeking to a particular frame corresponding to a known start time of the television program associated with the video clip. This is primarily to account for any record-time padding, as described above. At block 420, the quality of the current frame (initially the frame corresponding to the start time of the television program) is measured. The quality measurement may take into account such things as the frame's luminance, entropy, and the like. To save time and computation, the frame's gray histogram may be used. At block 430, a determination is made as to whether the quality of the current frame is greater than a quality threshold. If yes, then the current frame is used as the preliminary thumbnail (block 440). If not, then the following frame is examined (block 450), and so on until a suitable preliminary thumbnail is found.

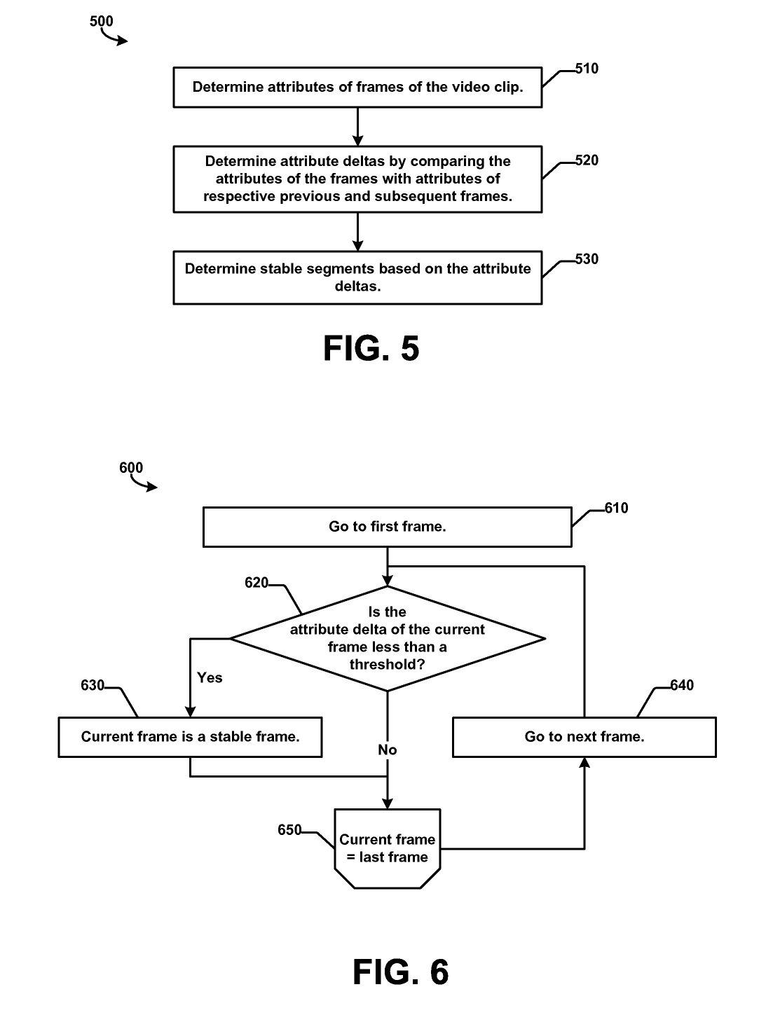

With reference again to FIG. 3, block 320 involves analyzing frames of the video clip to determine which frames are stable. As described above, a stable frame is a frame that exhibits a low degree of movement and/or change with respect to the preceding and following frames. The resulting stable frames make up a plurality of stable segments (i.e., one or more stable frames in sequence). It should be appreciated that this analysis may be achieved a number of ways. FIG. 5 illustrates a flowchart 500 of an example process of step 320 for analyzing frames of a video clip to determine which frames are stable, in accordance with an embodiment.

At block 510, attributes are determined for frames of the video clip. Such attributes may include, but are not limited to, color histograms, gray histograms, brightness, contrast, and the number of motion vectors in a given frame. Block 520 next involves determining attribute deltas by comparing the attributes of the frames with attributes of respective previous and subsequent frames. Next, in one embodiment, candidate segments are determined from the stable segments based on the attribute deltas (block 530). It should be appreciated that this may be achieved in a number of ways. For example, the attribute deltas may be compared to a threshold value, as explained with respect to the flowchart of FIG. 6.

FIG. 6 illustrates a flowchart 600 for determining stable segments based on a threshold value. At block 610, the first frame is loaded and is then analyzed to determine whether the attribute delta of that frame is less than a threshold (block 620). If yes, that frame is flagged as a stable frame (block 630). If not, that frame is considered to be a non-stable frame. Subsequent frames (block 640) are analyzed in a similar fashion until all have been completed (denoted by loop limit 650). Thereafter, by connecting the stable frames, the result is a set of stable video segments.

With reference again to FIG. 3, block 330 involves eliminating from consideration particular stable segments based on their lengths, in accordance with one embodiment. This may be accomplished, for example, by comparing the stable segments with a durational threshold. The removal of these short segment noises effectively smoothes out the series.

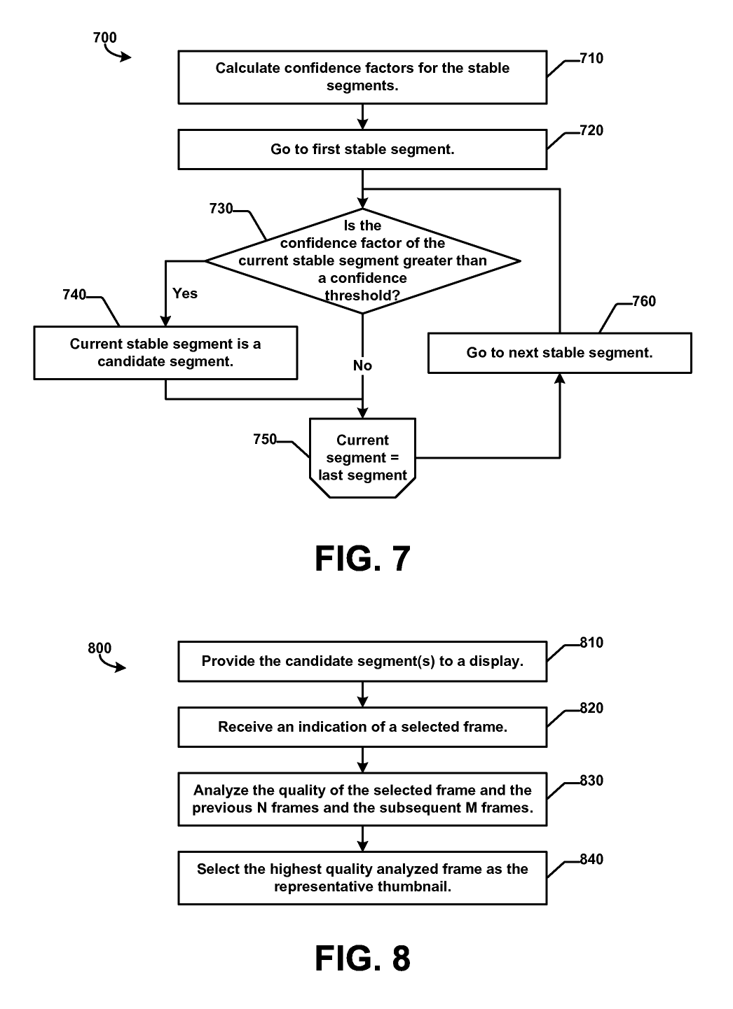

At block 340, a determination is made as to which of the stable segments are to be considered candidate segments. It should be appreciated that this determination may be achieved a number of ways. FIG. 7 illustrates a flowchart 700 of an example method of step 340 for determining which of the stable segments are to be candidate segments, in accordance with various embodiments. At block 710, confidence factors are calculated for the stable segments. This may involve first calculating confidence measures, as illustrated in Equations 1-5. The higher the measure is, the greater the possibility that the corresponding segment is a real program segment as opposed to a non-program segment.

After the calculation of confidence measures, the stable segments are assigned confidence factors based on the confidence measures. Once the confidence factors have been determined, the first stable segment is analyzed (block 720). This is to determine whether the confidence factor of that stable segment is greater than a confidence threshold. If yes, then that stable segment is flagged as a candidate segment (block 740). If not, then that stable segment will be considered a non-program segment. Subsequent stable segments (block 760) are analyzed in a similar fashion until all have been completed (denoted by loop limit 750).

With reference again to FIG. 3, block 350 involves selecting a representative thumbnail from the candidate segments determined in block 340. It should be appreciated this may be achieved in a number of ways. In one embodiment, the selection of the smart thumbnail is based on a strategy and/or rule. The strategy/rule may be predefined within the software application program of the present system, or the strategy/rule may be manually selected by a user from a plurality of options. Initially, one strategy may be preferred over the others as a default strategy. The strategies may include, but are not limited to: selecting the most stable frame in the highest confidence segment; selecting the highest contrast frame in the highest confidence segment; selecting a frame with a character face in the highest confidence segment; selecting the highest-quality frame in the highest confidence segment; and selecting the highest quality frame in the largest segment cluster. Detailed descriptions of these strategies have been provided above and need not be repeated here.

In one embodiment, the smart thumbnail is user-selected from the candidate segments. For example, FIG. 8 illustrates a flowchart 800 of an example method for selecting a representative thumbnail from the candidate segments, in accordance with an embodiment. At block 810, the candidate segments are provided on a display. The display may be a television, a computer monitor, or the like. Next, block 820 involves receiving an indication of a selected frame. The selection may be made via a user interface, for example. Due to higher frame rates, the frame selected by the user may not be the best quality frame as compared to neighboring frames. For example, a particular item in the picture may be blurred. Thus, at block 830, the qualities of the selected frame and a number of neighboring frames are analyzed. Then, at block 840, the highest quality of the analyzed frames is selected as the representative thumbnail.

It is appreciated that other methods may be used to select a representative thumbnail. Further methods are disclosed for example in U.S. Pat. No. 7,212,666 to Zhang, et al., entitled, “Generating Visually Representative Video Thumbnails,” which patent is assigned to the owner of the present invention and which patent is incorporated by reference herein in its entirety.

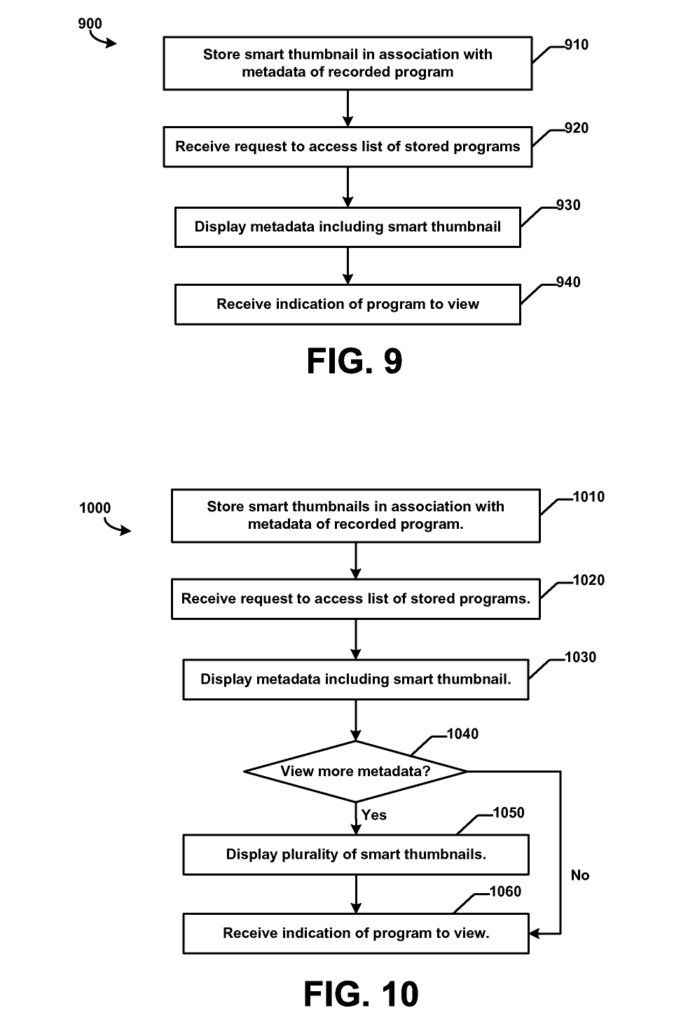

In accordance with the present system, one or more smart thumbnails 260 obtained as set forth above may be displayed along with other metadata in order to better allow viewers to identify recorded content. Referring now to flowchart 900 of FIG. 9, in one embodiment, a single smart thumbnail may be stored in the metadata of a recorded program in step 910. Thereafter, upon access of a list of stored programs in step 920, the present system may display metadata including smart thumbnail 260 in a step 930. As the smart thumbnail 260 contains a good representative video frame from the actual recorded program, the smart thumbnail allows the viewer to identify the recorded program better than conventional metadata. The viewer may then scan through the metadata of the various recorded programs and select the program they would like to view in step 940.

FIG. 10 shows a flowchart 1000 according to a further embodiment of the present system. In the embodiment of FIG. 10, several smart thumbnails 260 from a recorded program may be stored in the metadata of the recorded program. In particular, the present system may select several smart thumbnails with a high confidence level of being representative of program content as described above. In embodiments, the plurality of smart thumbnails may be successive frames of video. In alternative embodiments, the plurality of smart thumbnails may be from different stable segments determined as described above. In embodiments, there may be for example five to ten smart thumbnails selected, but there may be less than five or more than ten in alternative embodiments.

The plurality of thumbnails may be stored in association with the metadata of a recorded program in step 1010. Upon access of a list of stored programs in step 1020, the present system may display metadata including a single smart thumbnail 260 in a step 1030. In embodiments, at the user interface displaying the various recorded programs, the metadata for each program may display a single smart thumbnail 260. This may for example be the first smart thumbnail in the series of stored, sequential smart thumbnails. Alternatively, it may be the thumbnail that was selected as having the highest confidence factor of being representative of the program.

In step 1040, a user may select an option to view more metadata regarding the stored program. If so, the system displays the plurality of stored smart thumbnails associated with the stored program in step 1050. The thumbnails may be displayed side-by-side (or in any orientation) on the display, for example in a slide show format. In an alternative embodiment working with a sequential set of stored thumbnails, the thumbnails may be displayed sequentially in a short video clip of the recorded program. After the plurality of smart thumbnails is displayed, or if the viewer did not select to see additional metadata in step 1040, the system may then receive an indication from the viewer of a program to view in step 1060.

In embodiments described above, the picture content of a recorded program is used to generate representative thumbnails that are included in the metadata in order to allow viewers to better identify recorded programs. In alternative embodiments, it is understood that other representative data may be used for inclusion within the metadata of a recorded program. For example, it is contemplated that one or more representative audio recordings may be taken from a recorded program and stored in association with the recorded program metadata. The representative audio file may be obtained by a number of algorithms, including those which look for commonly used words, phrases and/or names in a broadcast. The algorithm may work by similar principles as the above-described thumbnail algorithm. The audio file may be stored in any of various known audio formats.

In use of the above embodiment, when a viewer accesses his or her recorded programs, there may be a soft button associated with each program, which, when accessed, plays the audio file. This feature may be used in addition to, or instead of, the smart thumbnail described above.

In a further embodiment, representative closed caption data for a recorded program may be stored in the metadata to allow identification of recorded programs. In particular, television recordings generally have closed caption data which is essentially a transcript of the show. An algorithm similar to the above-described thumbnail algorithm could be applied to select key written words, phrases and/or names. In embodiments, these words, phrases and/or names may be used in conjunction to create a summary of the recorded episode. The solution could be as simple as pulling out guests and topics by recognizing names being repeated, looking for names near key phrases like “welcome - - - ”, or “our guests today are - - - ”, etc.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A method for displaying a plurality of representative thumbnails from a video clip for assisting in the identification of the video clip, the method comprising:
(a) analyzing frames of said video clip to determine which of said frames are stable, wherein said frames determined to be stable compose one or more stable segments of said video clip;
(b) determining one or more candidate segments from said one or more stable segments, wherein said candidate segments are determined to a degree of certainty to be program segments;
(c) selecting a plurality of video frames from among said candidate segments;
(d) saving the plurality of video frames, as a plurality of thumbnails, in association with other metadata about the video clip;
(e) displaying one or more of the plurality of thumbnails in association with other metadata upon access of a list of stored video clips, the one or more thumbnails assisting in the identification of the video clip;
(f) receiving an indication to view the plurality of thumbnails; and
(g) displaying the plurality of thumbnails.

2. The method as recited in claim 1, wherein said step (g) of displaying the plurality of thumbnails comprises the step of displaying the thumbnails in a slide show display.

3. The method as recited in claim 1, wherein said step (g) of displaying the plurality of thumbnails comprises the step of displaying the thumbnails in succession as a sample video clip from the video clip.

4. The method as recited in claim 1, wherein said step (c) of selecting a plurality of video frames comprises the step of selecting a plurality of video frames based on a rule, said rule is selected from the group consisting of: the most stable frames in the candidate segment having the highest confidence factor; the highest contrast frames in the candidate segment having the highest confidence factor; particular frames that include one or more character faces in the candidate segment having the highest confidence factor; the highest quality frames in the candidate segment having the highest confidence factor; and the highest quality frames in the largest candidate segment cluster.

5. The method as recited in claim 1, wherein said step (c) of selecting a plurality of video frames comprises the step of selecting a plurality of video frames based on a rule, said rule is selected from the group consisting of: the second most stable frame in the candidate segment having the highest confidence factor, together with frames before and after the second most stable frame; and particular frames that include the second most frequently displayed character face in the candidate segment having the highest confidence factor.

6. The method as recited in claim 1, wherein the video clip is a recorded television program.

7. The method as recited in claim 6, wherein the recorded television program is a hosted television program, and said step (c) of selecting a plurality of video frames comprises the step of selecting a plurality of video frames depicting the host of the television program.

8. The method as recited in claim 6, wherein the recorded television program is a hosted television program, and said step (c) of selecting a plurality of video frames comprises the step of selecting a plurality of video frames depicting the guest on the television program.

9. A method for providing representative information from a recorded program for assisting in the identification of the recorded program, the method comprising:
(a) analyzing said recorded program to identify candidate segments of the recorded program that are determined to a degree of certainty to be segments from recorded program;
(b) selecting representative information from among said candidate segments;
(c) saving the representative information in association with other metadata about the recorded program; and
(d) displaying the representative information in association with other metadata upon access of a list of stored recorded programs.

10. The method as recited in claim 9, wherein the representative information is video frames and the recorded television program is a hosted television program, said step (b) of selecting representative information from among said candidate segments comprising the step of selecting a plurality of video frames depicting the host of the television program.

11. The method as recited in claim 9, wherein the representative information is video frames and the recorded television program is a hosted television program, said step (b) of selecting representative information from among said candidate segments comprising the step of selecting a plurality of video frames depicting the guest of the television program.

12. The method as recited in claim 9, wherein the representative information is closed captioning.

13. The method as recited in claim 12, wherein said recorded program is a hosted program, and step (b) of selecting representative information from among said candidate segments comprises the step of selecting closed captioning text identifying at least one of a host and a guest on the hosted program.

14. The method as recited in claim 9, wherein the representative information is an audio soundtrack of the recorded program.

15. The method as recited in claim 14, wherein said recorded program is a hosted program, and step (b) of selecting representative information from among said candidate segments comprises the step of selecting an audio segment identifying at least one of a host and a guest on the hosted program.

16. A system for selecting a plurality of thumbnails from a recorded program, wherein said thumbnail is representative of said program, the system comprising:
a stable program detector for determining one or more candidate segments from said video clip;
a thumbnail selector for selecting said representative thumbnails from among said candidate segments; and
a user interface, including a display and a selection device, the user interface including a display of a plurality of recorded programs, the display of each of the plurality of recorded programs including one or more of the plurality of representative thumbnails selected by the thumbnail selector, selection of a portion of the display of a recorded program via the selection device displaying all of the plurality of thumbnails selected by the thumbnail selector.

17. The system as recited in claim 16, wherein said stable program detector includes a pre-parser for detecting stable portions of the recorded program, the pre-parser including:
a feature extraction and analysis portion operable to calculate histograms for frames of said video clip; and
a system parameter tuning portion operable to calculate histo-differences based on the histograms of said frames and the histograms of respective previous and subsequent frames.

18. The system as recited in claim 16, wherein said representative thumbnails are of a person most prominently displayed in the recorded program.

19. The system as recited in claim 16, wherein said representative thumbnails are of the second most prominently displayed person in the recorded program.

20. The system as recited in claim 16, wherein said system is a digital video recorder.
